(19) United States
(12) Patent Application Publication
(10) Pub. No.: US 2022/0365619 A1
(43) Pub. Date: Nov. 17, 2022

(54) DISPLAY DEVICE WITH TOUCH PANEL

(71) Applicant: Sharp Display Technology Corporation, Kameyama City (JP)

(72) Inventors: Shugo KANO, Kameyama City (JP); Tomohiro KIMURA, Kameyama City (JP); Naru USUKURA, Kameyama City (JP); Yasuhiro SUGITA, Kameyama City (JP); Takuma YAMAMOTO, Kameyama City (JP)

(21) Appl. No.: 17/740,055

(22) Filed: May 9, 2022

(30) Foreign Application Priority Data
May 12, 2021 (JP) 2021-080874

(51) Int. Cl. G06F 3/041; G06F 3/01

(52) U.S. Cl. CPC G06F 3/0414; G06F 3/016

(57) ABSTRACT

A display device includes a first display configured to display a plurality of objects, and a touch panel overlapped with the first display in a plan view. The touch panel includes a pressing force sensor configured to detect a pressing force in each of the plurality of objects. The display device controls display of a second display in accordance with a function of an object with a pressing force detected, among the plurality of objects.

### CROSS-REFERENCE TO RELATED APPLICATIONS

This application claims the benefit of priority to Japanese Patent Application Number 2021-080874 filed on May 12, 2021. The entire contents of the above-identified application are hereby incorporated by reference.

### BACKGROUND

### Technical Field

The disclosure relates to a display device with a touch panel.

There has been known a display device with a touch panel that includes a touch panel. Such a display device with a touch panel is disclosed in, for example, JP 2018-106470 A.

The display device with the touch panel of JP 2018-106470 A described above includes a touch screen and a controller. The controller causes the touch screen to display a software keyboard. The software keyboard includes display of a plurality of keys (a plurality of objects). The controller acquires an input operation corresponding to the software keyboard in response to a user touching a key of the plurality of keys displayed on the touch screen. Then the controller executes a function corresponding to the input operation.

### SUMMARY

Here, when using a known mechanical keyboard, a user's hand often touches keys other than the key to be pressed by the user. Furthermore, the user's hand may touch the mechanical keyboard (for example, a home position) even during a period in which the user does not operate the mechanical keyboard. However, in the display device with the known touch panel described in JP 2018-106470 A, when a portion of the user's finger or hand touches the touch screen, a function corresponding to the software keyboard (object) is executed, and an unintended operation (erroneous operation) is likely to occur.

Thus, the disclosure has been conceived in order to solve the problems described above and aims to provide a display device with a touch panel capable of preventing the erroneous operation even in a case where a touch panel on which a plurality of objects are displayed is provided.

In order to solve the problem described above, a display device with a touch panel according to one aspect of the disclosure includes a display configured to display a plurality of objects, a touch panel overlapped with the display in a plan view, the touch panel including a pressing force sensor configured to detect a pressing force in each of the plurality of objects, and a controller configured to control the display and the touch panel, wherein the controller is configured to control display of the display in accordance with a function of an object with a pressing force detected, among the plurality of objects.

According to the configuration described above, it is possible to provide a display device with a touch panel capable of preventing an erroneous operation in a case where a touch panel on which a plurality of objects are displayed is provided.

### BRIEF DESCRIPTION OF DRAWINGS

The disclosure will be described with reference to the accompanying drawings, wherein like numbers reference like elements.

FIG. 1 is a block diagram illustrating a configuration of a display device 100 according to a first embodiment.

FIG. 2 is a plan view of the display device 100.

FIG. 3 is a cross-sectional view illustrating a configuration of a portion of the display device 100.

FIG. 4 is a schematic view illustrating a configuration of a pressing force sensor 11.

FIG. 5 is a functional block diagram of a controller 6.

FIG. 6A is a view illustrating an example of display of a first display 2.

FIG. 6B is a view illustrating an example of a second display 3.

FIG. 7A is a partial enlarged view of the first display 2 when a key “Back” is touched without being pressed.

FIG. 7B is an example of display of the second display 3 corresponding to an input operation in FIG. 7A.

FIG. 7C is a partial enlarged view of the first display 2 when the key “Back” is pressed.

FIG. 7D is a view illustrating an example of display of the second display 3 corresponding to an input operation in FIG. 7C.

FIG. 7E is a view illustrating an example of display of the second display 3 when the touch is cancelled.

FIG. 7F is an enlarged view of the first display 2 illustrating a state in which a pointer moves in a Y direction.

FIG. 7G is a view illustrating an example of display of the second display 3 corresponding to an input operation in FIG. 7F.

FIG. 8A is a view illustrating an example of a guide image displayed when a key “Tab” is pressed.

FIG. 8B is a view illustrating an example of display of the second display 3 corresponding to an input operation in FIG. 8A.

FIG. 9A is a view illustrating an example of a guide image G3 displayed when a key “Space” is pressed.

FIG. 9B is a view illustrating an example of display of the second display 3 corresponding to an input operation in FIG. 9A.

FIG. 10A is a view illustrating an example of a guide image G4 displayed when a key “Enter” is pressed.

FIG. 10B is a view illustrating an example of display of the second display 3 corresponding to an input operation in FIG. 10A.

FIG. 11A is a view illustrating an example of a guide image G5 displayed when a key “<” is pressed.

FIG. 11B is a view illustrating an example of display of the second display 3 corresponding to an input operation in FIG. 11A.

FIG. 12A is a view illustrating an example of a guide image G6 displayed when a character key “d” is pressed.

FIG. 12B is a view illustrating an example of display of the second display 3 corresponding to an input operation in FIG. 12A.

FIG. 13 is a view illustrating an example of display of the first display 2 when a key “Ctrl” is pressed.

FIG. 14 is a view illustrating an example of display of the first display 2 when a key “Shift” is pressed.

FIG. 15 is a view illustrating an example of display of the first display 2 when the keys “Ctrl” and “Alt” are pressed.

FIG. 16 is a flowchart illustrating an example of a control processing in accordance with movement of the pointer after pressing a touch panel 1.

FIG. 17 is a flowchart illustrating an example of a control processing when a pressing force on a plurality of objects K is detected.

FIG. 18 is a functional block diagram of a controller 206 of a display device 200 according to a second embodiment.

FIG. 19A is a view for describing an example of a thumbnail image and a preview image.

FIG. 19B is a view illustrating an example of display of the second display 3 when the thumbnail image is pressed.

FIG. 20A is a view of a screen example of the second display 3 before scrolling for describing a control processing related to a screen scroll.

FIG. 20B is a view of a screen example of the second display 3 during screen scroll at a lower speed.

FIG. 20C is a view of a screen example of the second display 3 during screen scroll at a higher speed.

FIG. 21 is a flowchart of a control processing in the display device 200 when a content is displayed on the second display 3.

FIG. 22 is a flowchart of a control processing in the display device 200 related to the screen scroll.

FIG. 23 is a plan view of a display device 300 according to a third embodiment.

FIG. 24 is a functional block diagram of a controller 306 of the display device 300 according to the third embodiment.

FIG. 25 is a cross-sectional view illustrating a portion of a display device 400 according to a fourth embodiment.

FIG. 26 is a cross-sectional view illustrating a portion of a display device 500 according to a modified example of the first to fourth embodiments.

### DESCRIPTION OF EMBODIMENTS

Hereinafter, embodiments of the disclosure will be described in detail with reference to the drawings. In the drawings, the same or corresponding portions are denoted by the same reference numerals and signs, and the description thereof will not be repeated. Note that, for ease of description, in the drawings referred to below, configurations may be simplified or schematically illustrated, and some components may be omitted. Furthermore, dimensional ratios between components illustrated in the drawings are not necessarily indicative of actual dimensional ratios.

### First Embodiment

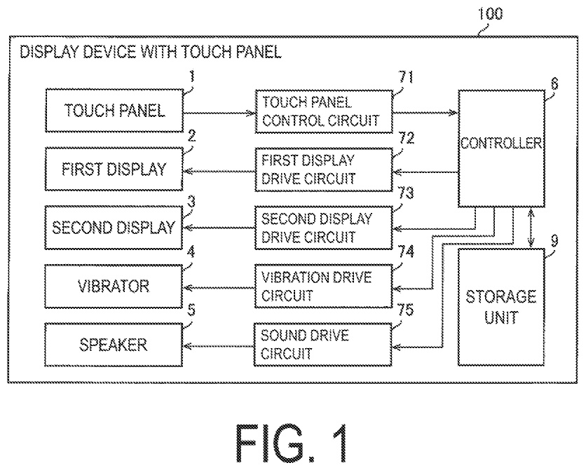

A configuration of a display device 100 with a touch panel (hereinafter referred to as “display device 100”) according to a first embodiment will be described. FIG. 1 is a block diagram illustrating the configuration of the display device 100 according to the first embodiment.

As illustrated in FIG. 1, the display device 100 includes a touch panel 1, a first display 2, a second display 3, a vibrator 4, a speaker 5, a controller 6, a touch panel control circuit 71, a first display drive circuit 72, a second display drive circuit 73, a vibration drive circuit 74, a sound drive circuit 75, and a storage unit 9.

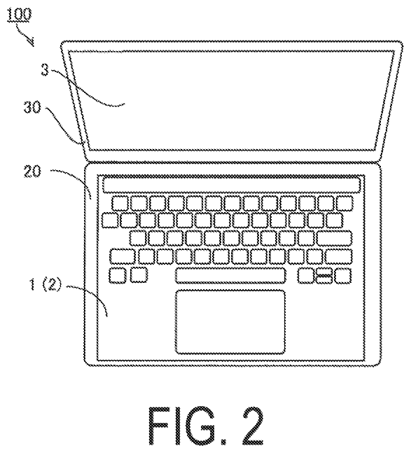

FIG. 2 is a plan view of the display device 100. As illustrated in FIG. 2, the touch panel 1 is disposed at a position overlapping with the first display 2 in a plan view. The display device 100 includes a first housing unit 20 and a second housing unit 30. The touch panel 1 and the first display 2 are disposed on the first housing unit 20. The second display 3 is disposed on the second housing unit 30. The first housing unit 20 and the second housing unit 30 are mechanically connected to each other by, for example, a hinge. The display device 100 is configured as a notebook PC, a mobile PC, a smartphone, a tablet terminal, or an electronic organizer, but is not limited thereto.

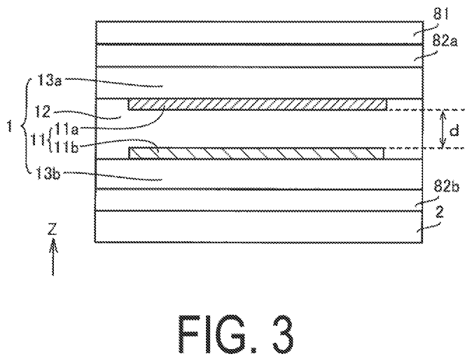

FIG. 3 is a cross-sectional view illustrating a configuration of a portion of the display device 100. As illustrated in FIG. 3, the display device 100 includes a cover glass 81 with which a pointer (for example, a finger of a user or a touch pen) comes into contact, an adhesive layer 82a for bonding the touch panel 1 and the cover glass 81, and an adhesive layer 82b for bonding the touch panel 1 and the first display 2. The adhesive layers 82a and 82b include an Optical Clear Adhesive (OCA).

As illustrated in FIG. 3, the touch panel 1 includes a pressing force sensor 11, a pressure sensitive layer 12, and substrates 13a and 13b. In the first embodiment, the pressing force sensor 11 is disposed closer to a touch surface side (Z direction) of the touch panel 1 than the first display 2. The “touch surface” is a surface of the cover glass 81 with which the pointer comes into contact. According to the configuration described above, the pressing force sensor 11 is disposed at a position closer to the touch surface than the first display 2, and thus a pressed position can be detected with high definition.

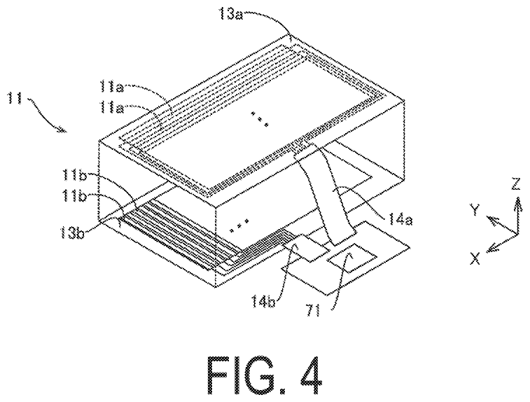

FIG. 4 is a schematic view illustrating a configuration of the pressing force sensor 11. As illustrated in FIG. 4, the pressing force sensor 11 includes a plurality of transmitter electrodes 11a and a plurality of receiver electrodes 11b. The plurality of transmitter electrodes 11a are formed side by side in the Y direction on the substrate 13a. The plurality of receiver electrodes 11b are formed to face the plurality of transmitter electrodes 11a via the pressure sensitive layer 12. The plurality of receiver electrodes 11b are formed side by side in the X direction on the substrate 13b. Each of the plurality of transmitter electrodes 11a is formed in a belt-shape so as to extend in the X direction. Each of the plurality of receiver electrodes 11b is formed in the belt-shape so as to extend in the Y direction. The plurality of transmitter electrodes 11a and the plurality of receiver electrodes 11b are formed in a lattice pattern in a plan view. Furthermore, the pressure sensitive layer 12 is made of a transparent material having elasticity, such as a polymer material or a piezoelectric element. The substrates 13a and 13b are formed of, for example, a film of a polyethylene terephthalate (PET).

As illustrated in FIG. 4, each of the plurality of transmitter electrodes 11a is connected to the touch panel control circuit 71 via a flexible printed circuit board 14a. Each of the plurality of receiver electrodes 11b is connected to the touch panel control circuit 71 via a flexible printed circuit board 14b. The touch panel control circuit 71 is connected to the controller 6 (see FIG. 1).

The vibrator 4 illustrated in FIG. 1 is disposed, for example, in the first housing unit 20 (see FIG. 2). The vibrator 4 vibrates the touch panel 1 (first housing unit 20) in response to a drive signal from the vibration drive circuit 74, thus transmitting a vibration to a user touching the touch panel 1. The speaker 5 outputs sound in response to a drive signal from the sound drive circuit 75.

The touch panel control circuit 71 illustrated in FIG. 1 supplies a drive signal to the plurality of transmitter electrodes 11a of the touch panel 1 in response to a command from the controller 6, and receives a detection signal from the plurality of receiver electrodes 11b. Here, when the pointer touches the touch panel 1, the pointer and a transmitter electrode 11a of the plurality of transmitter electrodes 11a is capacitively coupled to each other, and a charge amount between the transmitter electrode 11a and a corresponding one of the plurality of receiver electrodes 11b changes. The larger the magnitude of the pressing force (magnitude of pressure) due to the pointer is, the shorter a distance d between the transmitter electrode 11a and the receiver electrode 11b illustrated in FIG. 3 is. Thus, when the touch panel 1 is pressed by the pointer, the charge amount between the transmitter electrode 11a and the receiver electrode 11b changes, and the larger the magnitude of the pressing force is, the larger the amount of change in the charge amount is. Thus, when the charge amount changes, a waveform of the detection signal changes. The touch panel control circuit 71 calculates the magnitude of the pressing force based on the change in the detection signal. Then, the touch panel control circuit 71 outputs the magnitude of the pressing force to the controller 6. The touch panel control circuit 71 outputs the magnitude of the pressing force at one of at least two levels of a level equal to a predetermined threshold value described later or greater and a level smaller than the predetermined threshold value. In other words, the pressing force sensor 11 is configured to detect the magnitude of the pressing force at at least two levels. Furthermore, a type of detecting the magnitude of the pressing force (pressure detection) by the pressing force sensor 11 can use one of an electrostatic capacitance type and a piezo type, or a combination of these methods. The “electrostatic capacitance type” is a type for detecting the magnitude of the pressing force based on the change in the charge amount due to a change in electrostatic capacitance between the transmitter electrode 11a and the receiver electrode 11b. The “piezo type” is a type in which the pressure sensitive layer 12 between the transmitter electrode 11a and the receiver electrode 11b includes a piezoelectric element, and the magnitude of the pressing force is detected based on the change in the charge amount between the transmitter electrode 11a and the receiver electrode 11b due to a piezoelectric effect in the piezoelectric element.

Furthermore, the touch panel control circuit 71 sequentially supplies a drive signal to each of the plurality of transmitter electrodes 11a and receives a detection signal from each of the plurality of receiver electrodes 11b. The touch panel control circuit 71 calculates, based on the detection signal, a position touched by the pointer (coordinates of the touch position) and the magnitude of the pressing force at each touch position. Then, the touch panel control circuit 71 outputs the coordinates of the touch position and the magnitude of the pressing force at the coordinates to the controller 6.

The first display drive circuit 72 supplies a gate signal and a data signal to the first display 2 in response to the command from the controller 6, thus displaying an image or a video on the first display 2. The second display drive circuit 73 supplies the gate signal and the data signal to the second display 3 in response to the command from the controller 6, thus displaying an image or a video on the second display 3. The vibration drive circuit 74 supplies a drive signal to the vibrator 4 in response to the command from the controller 6, thus vibrating the vibrator 4. The sound drive circuit 75 supplies a drive signal to the speaker 5 in response to the command from the controller 6, thus outputting sound from the speaker 5.

The storage unit 9 illustrated in FIG. 1 includes a solid state drive (SSD) or a hard disk drive (HDD), for example. The storage unit 9 stores an operating system and a control program including an application program, executed by the controller 6. The application program includes an application program related to document editing, moving picture playback, and photo image display. Furthermore, the storage unit 9 stores a plurality of contents (data) including image and a plurality of photographs and sounds. In the following description, the operation system is described as an example using Windows (trade name), but the disclosure is not limited thereto. For example, any operating system such as MacOS (trade name), Linux (trade name), iOS (trade name), and Android (trade name) can be employed as an operating system other than the Windows. In other words, a keyboard array, key functions, and functions of shortcut keys are not limited to the example of Windows, and may be appropriately deformed in accordance with the operating system executed by the controller 6.

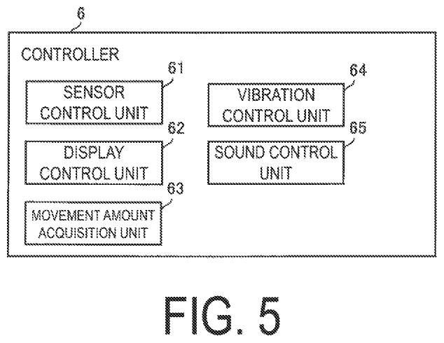

FIG. 5 is a functional block diagram of the controller 6. As illustrated in FIG. 5, the controller 6 functions as a sensor control unit 61, a display control unit 62, a movement amount acquisition unit 63, a vibration control unit 64, and a sound control unit 65 by executing the control program.

The sensor control unit 61 acquires the coordinates of the touch position and the magnitude of the pressing force at each coordinate from the touch panel control circuit 71. Then, the sensor control unit 61 functions as a determination unit for determining whether the touch panel 1 is pressed based on the magnitude of the pressing force at the touch position. For example, in a case where the magnitude of the pressing force is a predetermined threshold value or greater, the sensor control unit 61 determines that the touch panel 1 is pressed, and in a case where the magnitude of the pressing force is smaller than the predetermined threshold value, the sensor control unit 61 determines that the touch panel 1 is touched (a feather touch) without being pressed. In a case where the magnitude of the pressing force changes from a state of being the predetermined threshold value or greater to a state of being smaller than the predetermined threshold value, the sensor control unit 61 determines that the changed pressing force at the touch position is cancelled. According to this configuration, by appropriately setting the threshold value, it is possible to discriminate between the feather touch in which the user touches the touch panel 1 without intentional pressing force, and the intentional pressing force by the user with respect to the specific position by using the detection signal from the pressing force sensor 11. As a result, the touch position sensor is not required to be provided to the touch panel 1 separately from the pressing force sensor 11, and thus the configuration of the touch panel 1 can be simplified.

In a case where the sensor control unit 61 determines that the touch panel 1 is pressed, the vibration control unit 64 causes the vibrator 4 to vibrate the touch panel 1, and in a case where the sensor control unit 61 determines that the pressing force of the touch panel 1 is cancelled, the vibration control unit 64 causes the vibrator 4 to vibrate the touch panel 1. Thus, the user can recognize by the vibration whether the pressing force on the touch panel is detected by the display device 100 or whether the cancellation of the pressing force is detected by the display device 100.

The sound control unit 65 outputs sound (music) from the speaker 5 when playing the content.

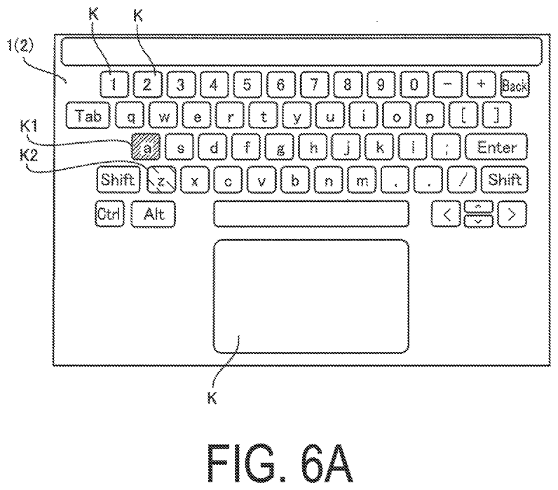

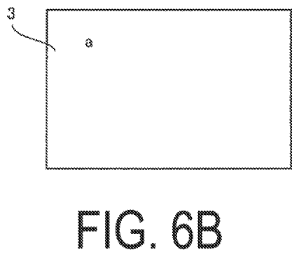

FIG. 6A is a view illustrating an example of display of the first display 2. FIG. 6B is a view illustrating an example of the second display 3. As illustrated in FIG. 6A, the display control unit 62 displays images of a software keyboard (plurality of objects K) and a track pad on the first display 2. Then, the display control unit 62 controls the display of the second display 3 in accordance with a function of an object K (for example, an object K1 in FIG. 6A) with a pressing force detected, among the plurality of objects K. According to this configuration, in a case where not only the touch panel 1 is touched but also the user intentionally presses the touch panel 1, the function of the object K is executed. Thus, in a case where the touch panel 1 configured to display the plurality of objects K is provided, it is possible to prevent an erroneous operation by the user.

In FIG. 6A, it is assumed that a position of a key “a” (object K1) is pressed, while a position of a key “z” (object K2) is touched. Furthermore, the key “z” is not pressed. In this case, the display control unit 62 displays “a” on the second display 3 as illustrated in FIG. 6B in response to the detection of the pressing force on the key “a”. Furthermore, the display control unit 62 highlights the pressed key “a” as illustrated in FIG. 6A. For example, the “a” is displayed in a color (dark color) different from that of keys other than the “a”. Thus, the key is visually recognized as being recessed. In a case where the touch is detected on the key “z” while the pressing force is not detected as illustrated in FIG. 6A, the display control unit 62 does not display (not input) the “z” on the second display 3 as illustrated in FIG. 6B. Furthermore, the display control unit 62 highlights the key “z” as illustrated in FIG. 6A. For example, the method for highlighting may be changed in accordance with the presence or absence of the pressing force. For example, the display control unit 62 displays the key (object K2) touched without being pressed on the first display 2 in a brighter color than the other keys, and displays the pressed key (object K1) on the first display 2 in a darker color than the other keys. Thus, the user can recognize whether the keys (objects K1 and K2) touched by the user are in a state of being pressed or in a state of not being pressed by viewing the display on the first display 2. As a result, an erroneous input can be further prevented.

### Control Processing in Accordance with Movement of Pointer after Pressing

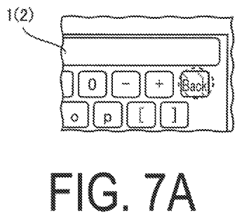

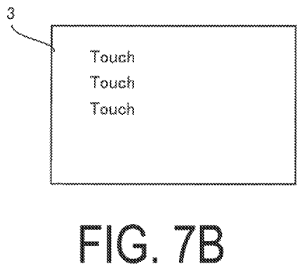

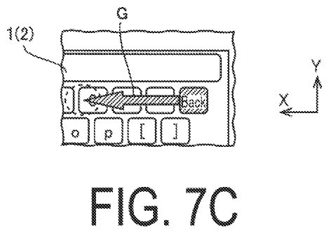

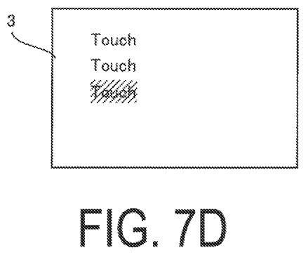

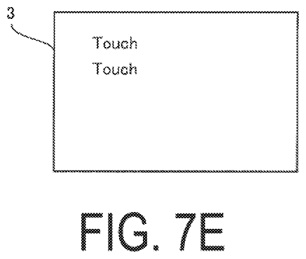

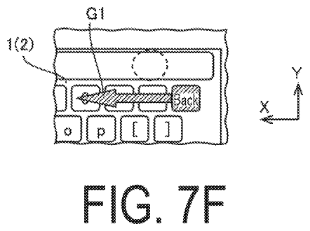

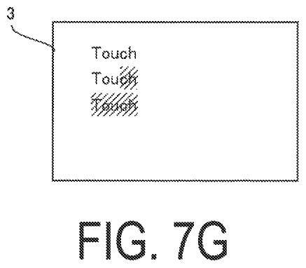

Next, with reference to FIGS. 7A to 13, a control processing in accordance with the movement of the pointer after pressing the touch panel 1 by the user will be described.

### Example of Key “Back”

First, referring to FIGS. 7A to 7G, an example of a control processing by the controller 6 related to a key “Back” (key “Backspace”) will be described.

FIG. 7A is a partial enlarged view of the first display 2 when the key “Back” is touched without being pressed. FIG. 7B is an example of display of the second display 3 corresponding to an input operation in FIG. 7A. Note that the dotted lines in FIGS. 7A, and 7C and 7F described below are each described for indicating the position of the pointer. As illustrated in FIG. 7A, when the key “Back” is touched, the display control unit 62 highlights the key “Back” on the first display 2. For example, as illustrated in FIG. 7B, it is assumed that three lines of characters “Touch” are displayed on the second display 3 and the cursor is positioned behind the character “Touch” in the third line.

FIG. 7C is a partial enlarged view of the first display 2 in a case where the key “Back” is pressed. FIG. 7D is an example of display of the second display 3 corresponding to an input operation in FIG. 7C. FIG. 7E is a view illustrating an example of display of the second display 3 in a case where the touch is cancelled. Here, as illustrated in FIG. 7C, in a case where the key “Back” is pressed, the display control unit 62 displays the guide image G on the first display 2. The guide image G is a view illustrating a direction in which the pointer is to be moved, and includes, for example, a figure of an “arrow” extending in the left direction from the key “Back”. Thus, the user can easily perform an operation in accordance with the display of the guide image G.

Here, the movement amount acquisition unit 63 (see FIG. 5) acquires the movement amount of the pointer based on the coordinates of the touch position. The movement amount acquisition unit 63 acquires a slide movement amount in the X direction (change in the coordinates) and a slide movement amount in the Y direction (change in the coordinates) from the coordinates of the touch position where the touch panel 1 is pressed. The display control unit 62 changes the function of the object K in accordance with the acquired movement amount. For example, as illustrated in FIG. 7C, in a case where the coordinates of the touch position move in the X direction along the guide image G after the key “Back” is pressed, the display control unit 62 increases a range (selection range) to which the function of the “Back” is applied as the movement amount in the X direction is larger. A portion indicated by the hatching in FIG. 7D is the selection range. For example, in a case where the movement amount in the X direction is small, only “h” is the selection range. In a case where the movement amount in the X direction is large, “Touch” is the selection range. As illustrated in FIG. 7E, the display control unit 62 executes the function of the “Back” in accordance with the cancellation of the touch (separation of the pointer from the touch panel 1) to delete the “Touch” in the third line.

FIG. 7F is an enlarged view of the first display 2 illustrating a state in which the pointer moves in the Y direction. In FIG. 7F, a state is illustrated in which the pointer has moved in the X direction (by two characters) along the guide image G1 and then has moved in the Y direction (by one line). FIG. 7G is an example of display of the second display 3 corresponding to an input operation of FIG. 7F. In other words, the “Touch” in the lowest line is the selection range, and in addition to this selection range, two characters “ch” in a line immediately above the lowest line are the selection range. In this way, the display control unit 62 changes the range (selection range) of lines to which the function of the “Back” is applied, as illustrated in FIG. 7G, in accordance with the movement amount in the Y direction. As a result, the function of the pressed object K can be changed in accordance with the movement amount of the pointer, and thus a physical input device such as a mouse is not required separately from the pointer. Thus, it is not necessary to switch the hand between the pointer and the physical input device, and thus operability of the display device 100 can be improved. Furthermore, a space for disposing the physical input device is not required.

### Example of Key “Tab”

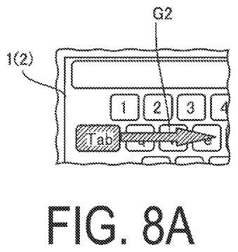

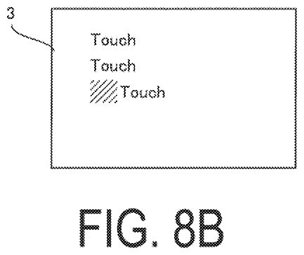

Next, referring to FIGS. 8A and 8B, an example of a control processing by the controller 6 related to a key “Tab” will be described. FIG. 8A is a view illustrating an example of a guide image displayed when the key “Tab” is pressed. FIG. 8B is an example of display of the second display 3 corresponding to an input operation in FIG. 8A. As illustrated in FIG. 8A, in a case where the key “Tab” is pressed, the display control unit 62 highlights the key “Tab” and displays a guide image G2 on the first display 2. The guide image G2 includes, for example, a figure of the “arrow” extending in the right direction from the key “Tab”. Then, the display control unit 62 acquires the movement amount of the pointer, and increases the function of the key “Tab” (for example, the function of increasing the indent) as the movement amount is larger. Then, in response to cancellation of the touch, the display control unit 62 inserts a blank (illustrated as hatching in FIG. 8B) having a size corresponding to the movement amount of the pointer before the “Touch” in the third line.

### Example of Key “Space”

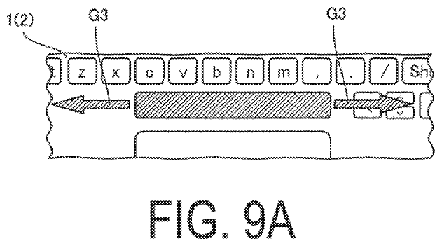

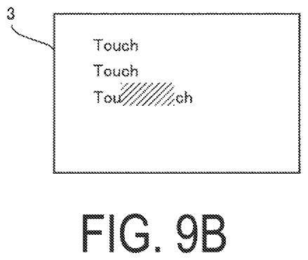

Next, referring to FIGS. 9A and 9B, an example of a control processing by the controller 6 related to a key “Space” will be described. FIG. 9A is a view illustrating an example of a guide image G3 displayed when the key “Space” is pressed. FIG. 9B is an example of display of the second display 3 corresponding to an input operation in FIG. 9A. As illustrated in FIG. 9A, when the key “Space” is pressed, the display control unit 62 highlights the key “Space” and displays the guide image G3 on the first display 2. The guide image G3 includes, for example, figures of the “arrow” each extending in a corresponding one of the left direction and the right direction from the key “Space”. Then, the display control unit 62 acquires the movement amount of the pointer, and increases the size of the blank inserted as the movement amount is larger. Then, as illustrated in FIG. 9B, in response to cancellation of the touch, the display control unit 62 inserts a blank (illustrated as hatching in FIG. 9B) having a size corresponding to the movement amount of the pointer between “u” an “c” in the third line.

### Example of Key “Enter”

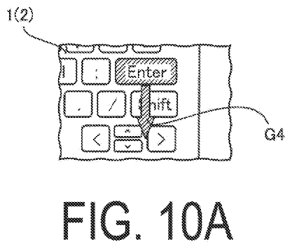

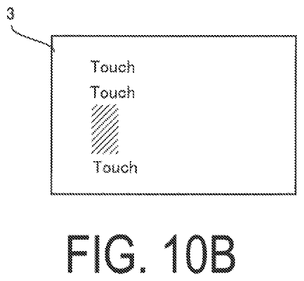

Next, referring to FIGS. 10A and 10B, an example of a control processing by the controller 6 related to a key “Enter” will be described. FIG. 10A is a view illustrating an example of a guide image G4 displayed when a key “Enter” is pressed. FIG. 10B is an example of display of the second display 3 corresponding to an input operation in FIG. 10A. As illustrated in FIG. 10A, when the key “Enter” is pressed, the display control unit 62 highlights the key “Enter” and displays the guide image G4 on the first display 2. The guide image G4 includes, for example, a figure of the “arrow” extending in the downward direction on a paper from the key “Enter”. Then, the display control unit 62 acquires the movement amount of the pointer, and increases the number of line feeds as the movement amount is larger. Then, as illustrated in FIG. 10B, in response to cancellation of the touch, the display control unit 62 executes the line feed.

### Example of Key “<”

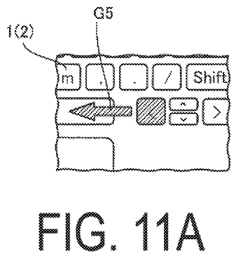

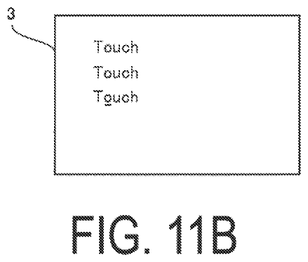

Next, referring to FIGS. 11A and 11B, an example of a control processing by the controller 6 related to a key “<” will be described. The key “<” is a key for moving the cursor position to the left. FIG. 11A is a view illustrating an example of a guide image G5 displayed when the key “<” is pressed. FIG. 11B is an example of display of the second display 3 corresponding to an input operation in FIG. 11A. As illustrated in FIG. 11A, when the key “<” is pressed, the display control unit 62 highlights the key “<” and displays the guide image G5 on the first display 2. The guide image G5 includes, for example, a figure of the “arrow” extending in the left direction from the key “<”. Then, the display control unit 62 acquires the movement amount of the pointer, and changes the position to be selected (cursor position) to a position in the further left direction as the movement amount is larger. Then, as illustrated in FIG. 11B, the display control unit 62 changes the position to be selected, (for example, changes the position from “h” to “o”) in response to cancellation of the touch. Note that the key “<” is described as an example, but also in other key “>” or the like, a guide image corresponding to the direction is displayed.

### Example of Character Key

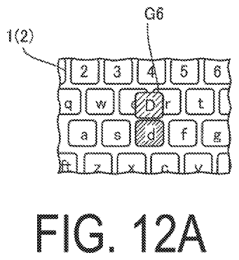

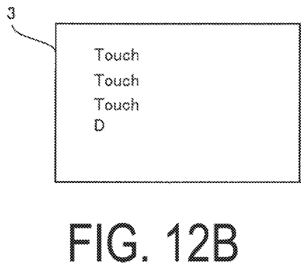

Next, referring to FIGS. 12A and 12B, an example of a control processing by the controller 6 related to character key will be described. FIG. 12A is a view illustrating an example of a guide image G6 displayed when a character key “d” is pressed. FIG. 12B is an example of display of the second display 3 corresponding to an input operation in FIG. 12A. As illustrated in FIG. 12A, when the character key “d” is pressed, the display control unit 62 highlights the key “d” and displays the guide image G6 on the first display 2. The guide image G6 is, for example, an image of an upper-case letter “D” corresponding to the character key “d”. Then, in response to the cancellation of the touch after the movement of the pointer from the character “d” toward the image of “D” is detected, the display control unit 62 causes the second display 3 to display the upper-case letter “D” as illustrated in FIG. 12B. Note that although the character key “d” is described as an example, the upper-case letters are also similarly displayed as guide images for other character keys.

### Control Processing by Pressing Force on a Plurality of Objects

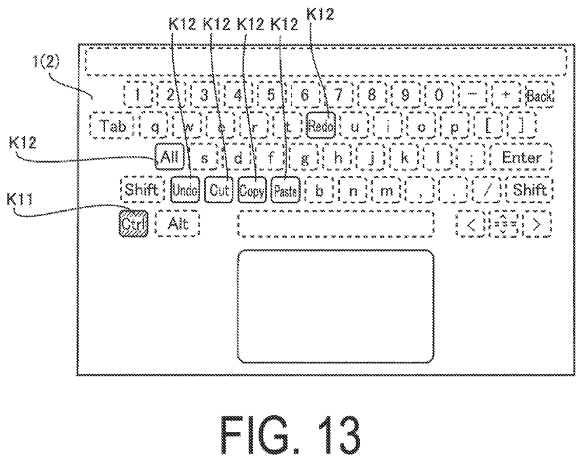

Next, with reference to FIGS. 13 to 15, a control processing executed by the pressing force on the plurality of objects will be described.

In the first embodiment, when the pressing force on a specific key K11 is detected, the controller 6 changes the display of the other objects (keys K12). Then, in response to pressing of the objects whose display are changed, the controller 6 executes functions after the change different from functions before the change of the objects. According to this configuration, the number of types of functions that can be operated on the touch panel 1 can be increased by a combination of the plurality of keys. Examples will be described below.

### Example of Key “Ctrl”

FIG. 13 is a view illustrating an example of display of the first display 2 when the key “Ctrl” is pressed as the specific key K11. In a case where the position of the key “Ctrl” is pressed on the touch panel 1, the display control unit 62 changes a color of the image of the key “Ctrl” and changes the display of the character keys, for example, “a”, “z”, “x”, “c”, “v”, “b”, and “y” as the keys K12 to keys “All”, “Undo”, “Cut”, “Copy”, “Paste”, and “Redo”, respectively. In other words, some of the character keys are changed to shortcut keys. For example, in a case where the key “All” is pressed, the controller 6 selects all items (for example, all characters) displayed on the first display 2. The operation functions of other shortcut keys are known, and thus descriptions thereof will be omitted. In FIG. 13, although keys “All”, “Undo”, “Cut”, “Copy”, “Paste”, and “Redo” are described as the examples, keys (shortcut keys) other than above-described keys may be set in the disclosure.

Furthermore, the display control unit 62 decreases the contrast of keys other than the keys “Ctrl”, “All”, “Undo”, “Cut”, “Copy”, “Paste”, and “Redo”. As a result, the keys (shortcut keys) whose functions have been changed are easily visually recognized. Furthermore, in a case where the pressing force on the key “Ctrl” is cancelled, the display control unit 62 returns the keys “All”, “Undo”, “Cut”, “Copy”, “Paste”, and “Redo” to the character keys “a”, “z”, “x”, “c”, “v”, “b”, and “y”, respectively.

### Example of Key “Shift”

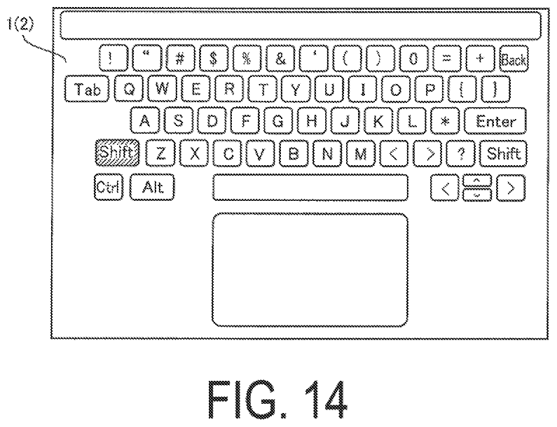

FIG. 14 is a view illustrating an example of display of the first display 2 when the key “Shift” is pressed as the specific key. In a case where the position of the key “Shift” is pressed on the touch panel 1, the display control unit 62 changes the color of the image of the key “Shift”, and changes, for example, the lower-case alphabet keys to upper-case alphabet keys and the numeric keys to symbol keys. In a case where the pressing force on the key “Shift” is cancelled, the display control unit 62 returns the upper-case alphabet keys to the lower-case alphabet keys and returns the symbol keys to the numeric keys.

### Example of Key “Alt”

In a case where a position of the key “Alt” is pressed as the specific key on the touch panel 1, the display control unit 62 changes the color of the image of the key “Alt” (not illustrated), and changes a plurality of keys to shortcut keys.

### Example of Keys “Ctrl”+“Alt”

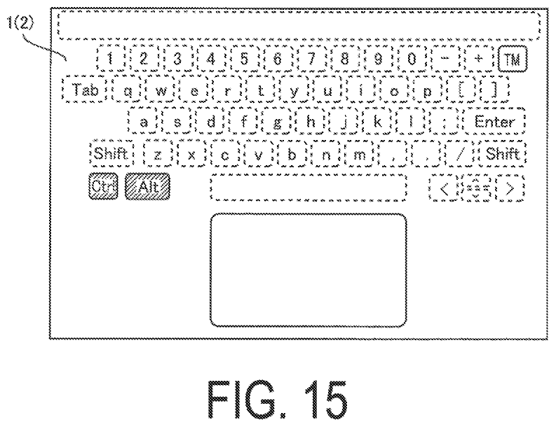

FIG. 15 is a view illustrating an example of display of the first display 2 when the keys “Alt” and “Shift” are pressed as the specific keys. In a case where a position of the key “Ctrl” is pressed and a position of the key “Alt” is pressed on the touch panel 1, the display control unit 62 changes the colors of the images of the key “Ctrl” and the key “Alt” and changes, for example, one of the plurality of keys to a key for starting a “task manager (TM)” (application management program).

### Other Examples

Note that in the disclosure, the control processing when the pressing force on the plurality of objects K is detected is not limited to the example described above, and may be modified as appropriate in accordance with an operating system and an application program executed by the controller 6.

### Flow of Control Processing by Display Device According to First Embodiment

### Example of Control Processing in Accordance with Movement of Pointer after Pressing Touch Panel

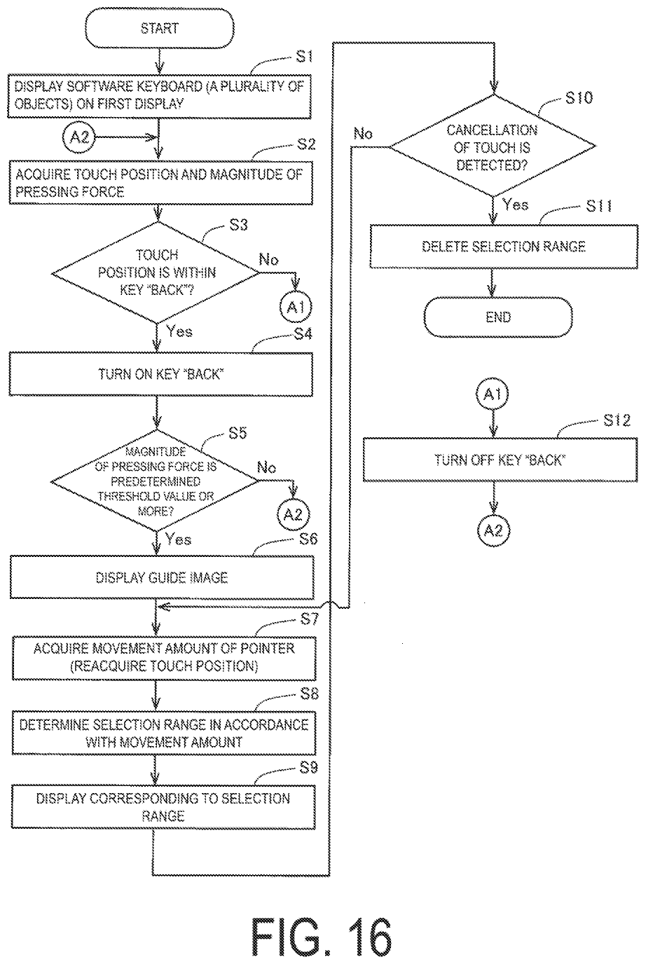

FIG. 16 is a flowchart illustrating an example of a control processing in accordance with movement of the pointer after pressing the touch panel 1. The control processing according to the first embodiment is executed by the controller 6. Note that although FIG. 16 illustrates an example relating to the key “Back”, the above-described key “Tab” and the like are also subjected to the control processing similarly to the example relating to the key “Back”.

As illustrated in FIG. 16, in step S1, the software keyboard (plurality of objects K) is displayed on the first display 2. In step S2, the touch position and the magnitude of the pressing force are acquired from the touch panel control circuit 71.

In step S3, it is determined whether the touch position is within the range of the key “Back”. If the touch position is within the range of the key “Back”, then, in step S4, the key “Back” is turned on. For example, in the case of FIG. 7A, the display of the key “Back” is changed to the brighter color than other keys. If the touch position is outside the range of the key “Back”, then the process proceeds to step S12. If the key “Back” is turned on, then, in step S12, the key “Back” is turned off. After step S12, the process returns to step S2.

In step S5, it is determined whether the magnitude of the pressing force is the predetermined threshold value or larger. If the magnitude of the pressing force is the predetermined threshold value or greater, then, in step S6, the guide image G is displayed on the first display 2. If the magnitude of the pressing force is smaller than the predetermined threshold value, then the process returns to step S2.

In step S7, the touch position is repeatedly acquired, and the movement amount of the pointer is acquired. In step S8, the selection range is determined in accordance with the movement amount (see FIGS. 7D and 7G). In step S9, the display corresponding to the selection range is performed on the second display 3. For example, in the examples of FIGS. 7D and 7G, a background color of the characters corresponding to the selection range is changed (illustrated by hatching in FIGS. 7D and 7G). In step S10, it is determined whether the cancellation of the touch is detected. If the cancellation of the touch (separation of the pointer from the touch panel 1) is detected, then the process proceeds to step S11, and in step S11, the characters in the selection range are deleted on the second display 3. If the cancellation of the touch is not detected, then the process returns to step S7. Thereafter, the control processing in accordance with movement of the pointer after pressing the touch panel 1 ends.

### Flow of Control Processing when Pressing Force on a Plurality of Objects is Detected

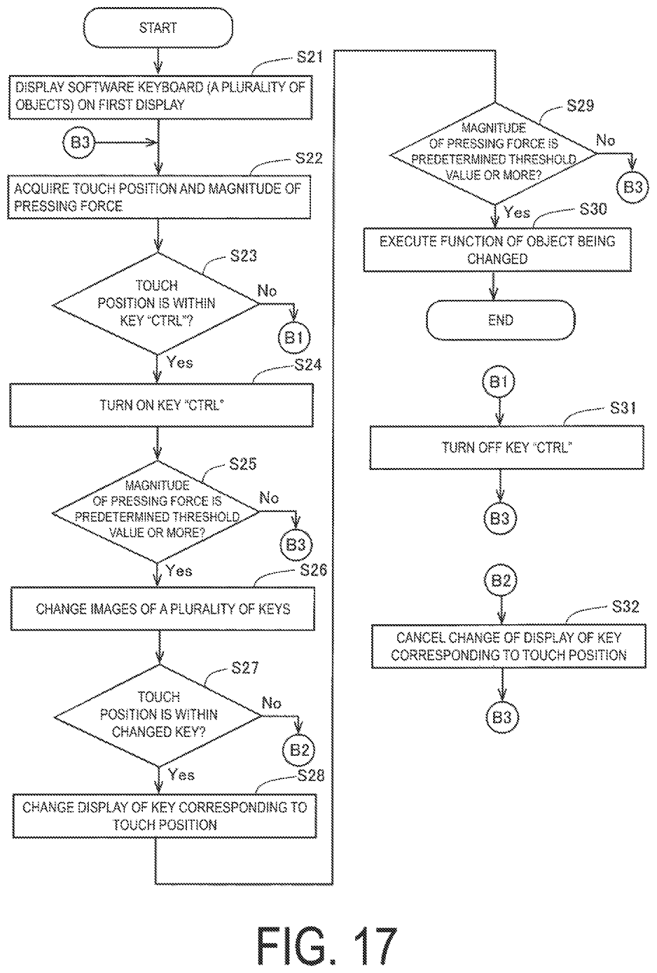

FIG. 17 is a flowchart illustrating an example of a control processing when the pressing force on the plurality of objects K is detected. Note that although FIG. 17 illustrates an example relating to the key “Ctrl” as the specific key, the above-described key “Shift” and the like are also subjected to the control processing similarly to the example relating to the key “Ctrl”.

As illustrated in FIG. 17, in step S21, the software keyboard is displayed. In step S22, the touch position and the magnitude of the pressing force are acquired.

In step S23, it is determined whether the touch position is within the range of the specific key (key “Ctrl”). If the touch position is within the range of the key “Ctrl”, then, in step S24, the key “Ctrl” is turned on. For example, in the case of FIG. 13, the display of the key “Ctrl” is changed to the brighter color than other keys. If the touch position is outside the range of the key “Ctrl”, then the process proceeds to step S31. If the key “Ctrl” is turned on, then, in step S31, the key “Ctrl” is turned off. After step S31, the process returns to step S22.

In step S25, it is determined whether the magnitude of the pressing force at the touch position of the key “Ctrl” is the predetermined threshold value or greater. If the magnitude of the pressing force is the predetermined threshold value or greater, then, in step S26, an image of each of a plurality of keys is changed to an image of a corresponding one of shortcut keys. If the magnitude of the pressing force is smaller than the predetermined threshold value, then the process returns to step S22.

In step S27, it is determined whether the touch position is within the range of the changed keys (shortcut keys). If the touch position is within the range of the changed keys (shortcut keys), then, in step S28, the display of the key corresponding to the touch position is changed. If the touch position is outside the range of the changed keys (shortcut keys), then the process proceeds to step S32. If the display of the key corresponding to the touch position is changed, then, in step S32, the change of the display of the key corresponding to the touch position is cancelled (the display is returned to the original). Then, after step S32, the process returns to step S22.

In step S29, it is determined whether the magnitude of the pressing force at the touch position of the changed key (shortcut key) is the predetermined threshold value or greater. If the magnitude of the pressing force is the predetermined threshold value or greater, then the process proceeds to step S30, and in step S30, the function of the changed key (shortcut key) is executed. If the magnitude of the pressing force is smaller than the predetermined threshold value, then the process returns to step S22. Thereafter, the control processing when the pressing force on the plurality of objects K is detected ends.

### Second Embodiment

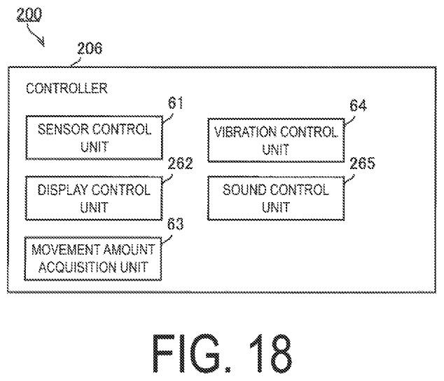

Next, with reference to FIGS. 18 to 20C, a configuration of a display device 200 with a touch panel (hereinafter referred to as “display device 200”) according to a second embodiment will be described. In the second embodiment, a content corresponding to a thumbnail image P1 in which the pressing force is detected by the touch panel 201 is displayed on the second display 3. Note that, in the following description, when the same reference numerals as in the first embodiment are used, the same configurations as in the first embodiment are indicated, and reference is made to the preceding description unless otherwise described.

FIG. 18 is a functional block diagram of a controller 206 of the display device 200 according to the second embodiment. As illustrated in FIG. 18, the controller 206 functions as a display control unit 262 and a sound control unit 265 by executing a control program.

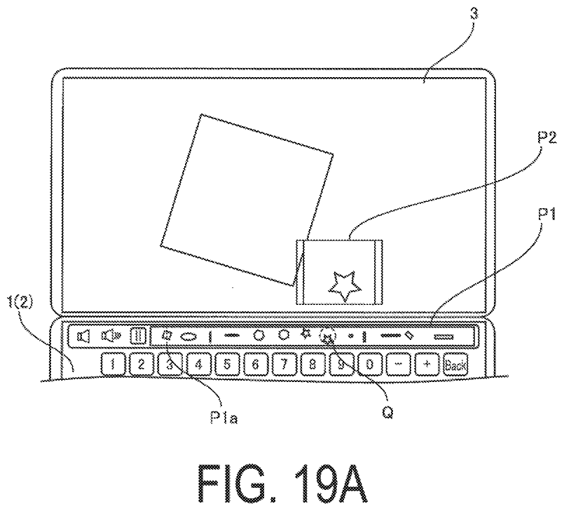

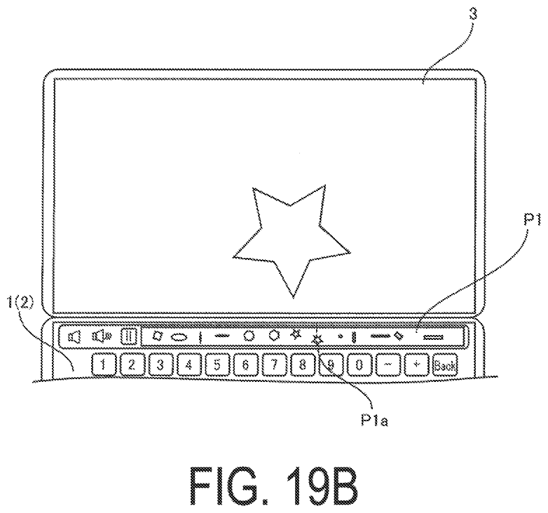

FIG. 19A is a view for describing an example of the thumbnail image P1 and a preview image P2. FIG. 19B is a view illustrating an example of display of the second display 3 when the thumbnail image P1 is pressed. As illustrated in FIG. 19A, the display control unit 262 causes the second display 3 to display a moving picture content and causes a portion of the first display 2 closer to the second display 3 side to display the thumbnail image P1 of the moving picture content as the object. The thumbnail image P1 is an image in which images of a plurality of scenes in the moving picture content are aligned and combined. The image P1a in FIG. 19A is an image indicating a playback position of the moving picture content on the thumbnail image P1. A dotted line Q indicates the touch position of the pointer on the thumbnail image P1. Note that in the example of FIG. 19A, the thumbnail images are displayed in the belt-shape as an example of the thumbnail image P1, but the thumbnail images may be displayed in a matrix shape (tile shape).

In a case where the thumbnail image P1 is touched at the position of the dotted line Q by the user, the display control unit 262 causes the second display 3 to display the preview image P2 based on the thumbnail image P1 (an image of a star in the dotted line Q in FIG. 19A) corresponding to the touch position. For example, the display control unit 262 causes the second display 3 to display an image (a quadrangular image in FIG. 19A) corresponding to a playback position of the image P1a. Furthermore, the display control unit 262 causes the second display 3 to display the preview image P2.

The content corresponding to the position of the dotted line Q of the thumbnail image P1 is an image in which the image of the star is displayed. As illustrated in FIG. 19B, the display control unit 262 causes the second display 3 to display a content corresponding to the position of the dotted line Q of the thumbnail image P1 in which the pressing force is detected in the touch panel 1. In other words, the display control unit 262 causes the moving picture content to be played from the image in which the image of the star is displayed in the moving picture content. Furthermore, the image P1a indicating the playback position moves to the pressed position in the thumbnail image P1. The sound control unit 265 outputs, from the speaker 5, sound corresponding to the content corresponding to the position of the dotted line Q of the thumbnail image P1 in which the pressing force is detected. As a result, the content desired by the user from among the content of the thumbnail image P1 can be easily displayed on the second display 3 by the pressing force by the user. Then, the user touches a part of the thumbnail image P1, and while confirming the preview image P2 corresponding to the touch position, presses the touch panel 1 when a desired preview image P2 is displayed, and thus the user can display a content desired by the user on the second display 3. Note that, in the example described above, the moving picture content is described as the example, but in the disclosure, the content of the second embodiment may be applied to a photo album content constituted by a plurality of pieces of photo data.

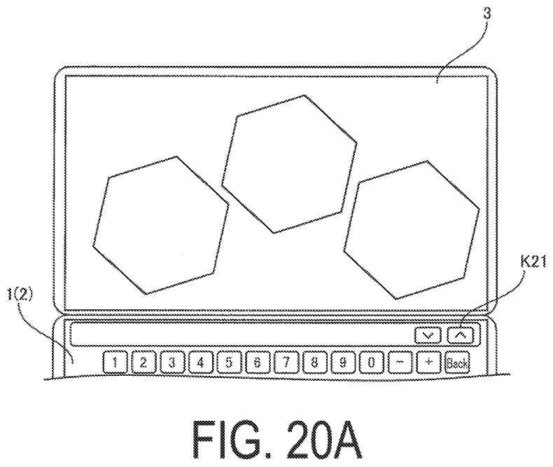

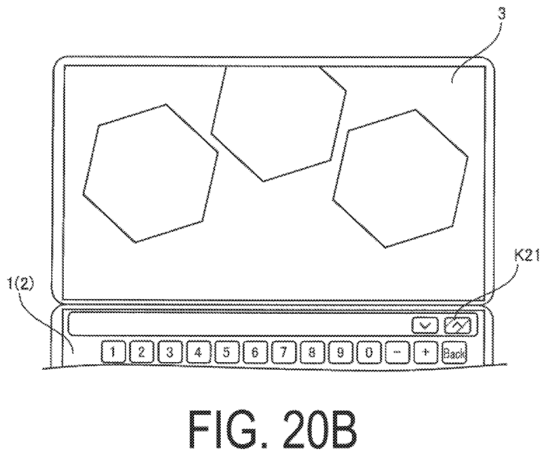

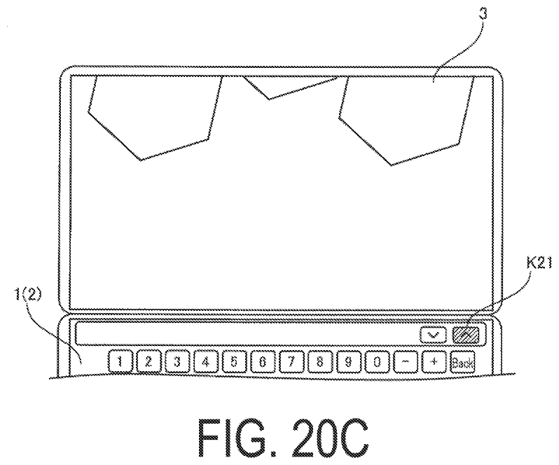

FIG. 20A is a view of a screen example of the second display 3 before a scroll for describing a control processing related to a screen scroll. FIG. 20B is a view of a screen example of the second display 3 during a screen scroll at a lower speed. FIG. 20C is a view of a screen example of the second display 3 during a screen scroll at a higher speed. As illustrated in FIG. 20A, the display control unit 262 displays an object (referred to as a screen scroll object K21) performing the screen scroll on the first display 2.

In a case where the screen scroll object K21 is touched without being pressed, the display control unit 262 performs the screen scroll of the image displayed on the second display 3 at the lower speed than when the screen scroll object K21 is pressed, as illustrated in FIG. 20B. In a case where the screen scroll object K21 is pressed, the display control unit 262 performs the screen scroll of the image displayed on the second display 3 at the higher speed than when the screen scroll object K21 is touched without being pressed. The display control unit 262 determines the speed of the screen scroll based on the magnitude of the pressing force. For example, the display control unit 262 increases the speed of the screen scroll as the magnitude of the pressing force is larger. According to this configuration, the speed of the screen scroll can be changed in accordance with the magnitude of the pressing force by the user. For example, in a case where the user desires to increase the speed of the screen scroll, the speed of the screen scroll can be easily increased by increasing the magnitude of the pressing force.

### Flow of Control Processing of Display Device According to Second Embodiment

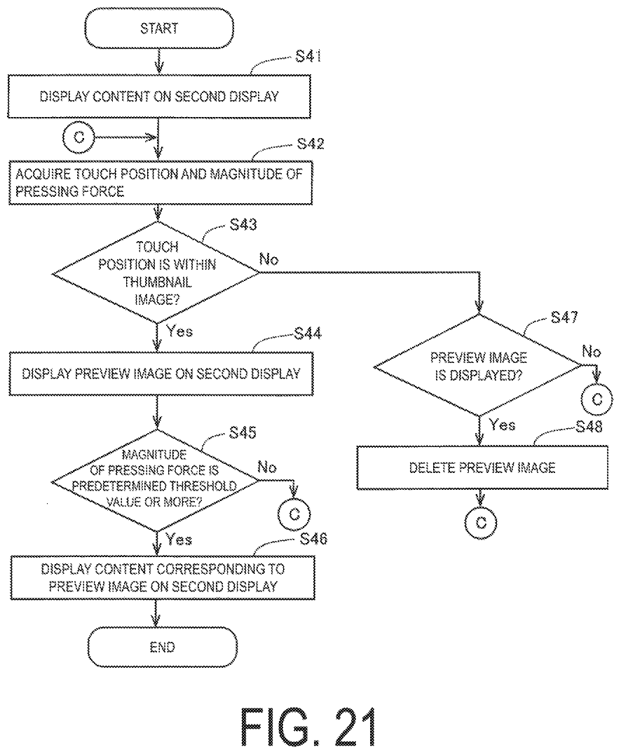

FIG. 21 is a flowchart of a control processing in the display device 200 when a content is displayed on the second display 3.

As illustrated in FIG. 21, in step S41, the content is displayed on the second display 3. In step S42, the touch position and the magnitude of the pressing force are acquired.

In step S43, it is determined whether the touch position is within the range of the thumbnail image. If the touch position is within the range of the thumbnail image, then, in step S44, the preview image of the content corresponding to the thumbnail image being touched is displayed on the second display 3. If the touch position is outside the range of the thumbnail image, then the process returns to step S42.

In step S45, it is determined whether the magnitude of the pressing force at the touch position of the thumbnail image is the predetermined threshold value or greater. If the magnitude of the pressing force is the predetermined threshold value or greater, then the process proceeds to step S46, and if the magnitude of the pressing force is smaller than the predetermined threshold value, then the process returns to step S42. Then, in step S46, the content corresponding to the preview image is displayed on the second display 3. Thereafter, the control processing in the display device 200 when the content is displayed on the second display 3 ends.

Furthermore, in step S47 to which the process proceeds when the touch position is outside the range of the thumbnail image in step S43, it is determined whether the preview image is displayed on the second display 3. If the preview image is displayed on the second display 3, then, in step S48, the preview image is deleted. Thereafter, the process returns to step S42.

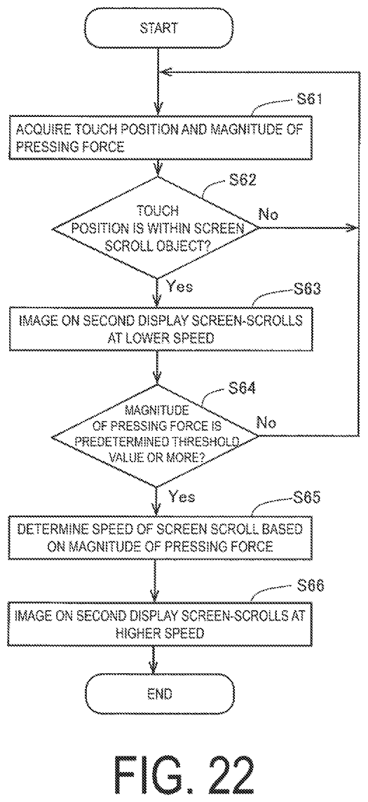

FIG. 22 is a flowchart of a control processing in the display device 200 related to the screen scroll.

As illustrated in FIG. 22, in step S61, the touch position and the magnitude of the pressing force are acquired. In step S62, it is determined whether the touch position is within the range of the screen scroll object. If the touch position is within the range of the screen scroll object, then, in step S63, the image displayed on the second display 3 is screen-scrolled at the lower speed. If the touch position is outside the range of the screen scroll object, then the process returns to step S61.

In step S64, it is determined whether the magnitude of the pressing force at the touch position of the screen scroll object is a predetermined threshold value or greater. If the magnitude of the pressing force is the predetermined threshold value or greater, then the process proceeds to step S65, and if the magnitude of the pressing force is smaller than the predetermined threshold value, then the process returns to step S61. Then, in step S65, the speed of the screen scroll is determined based on the magnitude of the pressing force. For example, as the magnitude of the pressing force is larger, the speed of the screen scroll is set to be higher. In step S66, the image displayed on the second display 3 is screen-scrolled at a higher speed (speed determined in step S65). Thereafter, the control processing in the display device 200 related to the screen scroll ends. Note that other configurations and effects are similar to the configurations and effects in the first embodiment.

### Third Embodiment

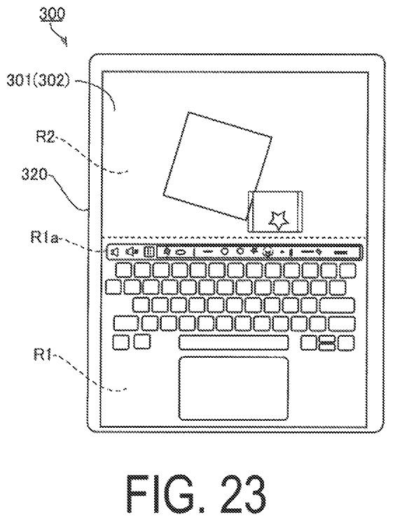

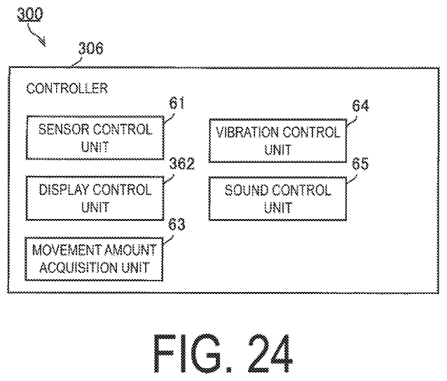

Next, with reference to FIGS. 23 and 24, a configuration of a display device 300 with a touch panel (hereinafter referred to as “display device 300”) according to a third embodiment will be described. In the third embodiment, the display device 300 is configured as a tablet terminal provided with a single display 302. Note that, in a case in which the same reference numerals as in the first or second embodiment are used in the following description, they represent the same configurations as in the first or second embodiment, and reference is made to the preceding description unless otherwise described.

FIG. 23 is a plan view of the display device 300 according to the third embodiment. FIG. 24 is a functional block diagram of a controller 306 of the display device 300 according to the third embodiment. As illustrated in FIG. 23, in the display device 300, a touch panel 301 and the display 302 are disposed to overlap with each other in a plan view. As illustrated in FIG. 24, the controller 306 functions as a display control unit 362 by executing a control program.

As illustrated in FIG. 23, the display control unit 362 causes a portion of the display 302 to display the software keyboard and the thumbnail images as an object display region R1. The display control unit 362 causes the other portion of the display 302 to display a content as a content display region R2. The “thumbnail images” are images arranged for each of scenes of the moving picture contents played in the content display region R2, and are similar to the thumbnail images illustrated in the second embodiment. A thumbnail image display region R1a in which thumbnail images are displayed is provided in the object display region R1. In other words, in a case where the thumbnail image is touched without being pressed, a preview image corresponding to the thumbnail image being touched is displayed in the content display region R2. Furthermore, in a case where the thumbnail image is pressed, a content corresponding to the thumbnail image being pressed is displayed in the content display region R2. The software keyboard displayed in the object display region R1 functions similarly to the software keyboard illustrated in the first embodiment. Note that other configurations and effects are similar to the configurations and effects in the first or second embodiment.

### Fourth Embodiment

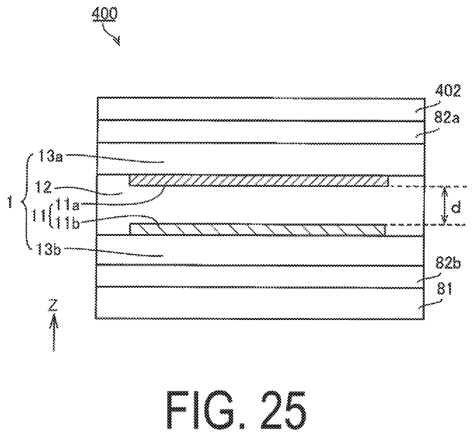

Next, with reference to FIG. 25, a configuration of a display device 400 with a touch panel (hereinafter referred to as “display device 400”) according to a fourth embodiment will be described. In the fourth embodiment, the display device 400 is provided with a display 402 having flexibility. Note that, in a case in which the same reference numerals as those of any of the first to third embodiments are used in the following description, they represent similar configurations to those of any of the first to third embodiments, and reference is made to the preceding description unless otherwise described.

FIG. 25 is a cross-sectional view illustrating a portion of the display device 400 according to the fourth embodiment. The display 402 of the display device 400 is disposed, for example, closer to a touch surface side (Z direction) than the touch panel 1. The display 402 has flexibility and is a display having flexibility equivalent to, for example, an organic light emitting diode (OLED), a micro LED, a quantum dot light emitting diode (QD-LED), and a display including these. According to this configuration, even in a case where the pressing force sensor 11 is disposed on the opposite side to the touch surface of the touch panel than the display 402, the pressing force can be transmitted to the pressing force sensor 11 via the display 402 having flexibility while preventing the resolution of the pressing force sensor 11 from being decreased. Note that other configurations and effects are similar to the configurations and effects in any of the first to third embodiments.

### Modifications and the Like

The above-described embodiments are merely examples for carrying out the disclosure. Accordingly, the disclosure is not limited to the embodiments described above and can be implemented by modifying the embodiments described above as appropriate without departing from the scope of the disclosure.

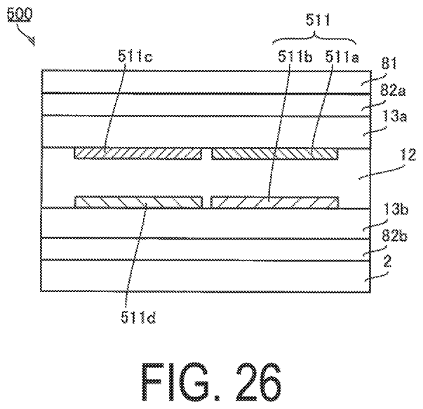

(1) In each of the above-described first to fourth embodiments, the example is illustrated in which both the touch position and the magnitude of the pressing force are detected using the pressing force sensor, but the disclosure is not limited to this example. A display device 500 with a touch panel according to a modified example illustrated in FIG. 26 includes a floating electrode 511c and a touch position sensor electrode 511d in addition to a pressing force sensor 511 including a drive electrode 511a and a receiver electrode 511b. In a case where the pointer touches the cover glass 81, the drive electrode 511a and the floating electrode 511c are capacitively coupled to each other, and the floating electrode 511c and the touch position sensor electrode 511d are capacitively coupled to each other. As a result, a touch panel control circuit (not illustrated) can detect the touch position based on a detection signal from the touch position sensor electrode 511d.

(2) In each of the above-described first to fourth embodiments, the example is illustrated in which the pressing force sensor is configured to be capable of detecting the magnitude of the pressing force at two levels of smaller than the predetermined threshold value and the predetermined threshold value or greater, but the disclosure is not limited to this example. In other words, the pressing force sensor may be configured to be capable of detection at three or more levels by providing a plurality of threshold values.

(3) In each of the above-described first to fourth embodiments, the example is illustrated in which it is determined whether the touch panel is pressed by the controller, but the disclosure is not limited to this example. For example, it may be determined whether the touch panel is pressed by the touch panel control circuit.

(4) In the above-described first embodiment, the images of the arrows and the upper-case letters are illustrated as the example of the guide image, but the disclosure is not limited to this example. For example, a graphic such as a triangle or a circle may be used as the guide image.

(5) In the second embodiment described above, the example is illustrated in which in a case where the screen scroll object is touched without being pressed, the screen scroll is performed at the lower speed, and in a case where the screen scroll object is pressed, the screen scroll is performed at the higher speed, but present the disclosure is not limited to this example. For example, in a case where the screen scroll object is touched without being pressed, the screen scroll need not be performed, and in a case where the screen scroll object is pressed, the screen scroll may be performed.

(6) In the above-described fourth embodiment, an example is illustrated in which the display having flexibility is disposed closer to the touch surface side than the touch panel, but the disclosure is not limited to this example. For example, the display having flexibility may be disposed on the opposite side to the touch surface than the touch panel.

The display device with a touch panel described above can be described as follows.

A display device with a touch panel according to a first configuration includes a display configured to display a plurality of objects, a touch panel overlapped with the display in a plan view, the touch panel including a pressing force sensor configured to detect a pressing force in each of the plurality of objects, and a controller configured to control the display and the touch panel, wherein the controller is configured to control display of the display in accordance with a function of an object with a pressing force detected, among the plurality of objects (first configuration).

According to the above-described first configuration, in a case where not only the touch panel is touched but also the user intentionally presses the touch panel, the function of the object is executed and is reflected on the display of the display. Thus, in a case where the touch panel on which the plurality of objects are displayed is provided, it is possible to prevent an erroneous operation.

In the first configuration, the pressing force sensor may be configured to detect a magnitude of pressing force at at least two levels, and the controller may further include a determination unit configured to determine whether a touch position is pressed based on the magnitude of pressing force at the touch position, the touch position being a position where the touch panel is touched (second configuration).

According to the above-described second configuration, by appropriately setting the threshold value, it is possible to discriminate between the feather touch in which the user touches the touch panel without intentional pressing force, and the intentional pressing force by the user with respect to the specific position by using the detection signal from the pressing force sensor. As a result, the touch position sensor is not required to be provided to the touch panel separately from the pressing force sensor, and thus the configuration of the touch panel can be simplified.

In the second configuration, the controller may be configured to cause the display to display the guide image after the determination unit determines that the touch position is pressed (third configuration).

According to the above-described third configuration, the user can easily perform an operation in accordance with the display of the guide image.

In the second or third configuration, the controller may further include a movement amount acquisition unit configured to acquire the movement amount of a pointer based on coordinates of the touch position, and the controller may be configured to change, in accordance with the movement amount, the function of the object corresponding to the touch position determined to be pressed by the determination unit (fourth configuration).

According to the above-described fourth configuration, the function of the pressed object can be changed in accordance with the movement amount of the pointer, and thus a physical input device such as a mouse is not required separately from the touch panel. Thus, it is not necessary to switch the hand between the touch panel and the physical input device, and thus the operability of the display device with the touch panel can be improved. Furthermore, a space for disposing the physical input device is not required.

In any one of the first to fourth configurations, the controller may be configured to change display of at least one object other than the object with the pressing force detected, and in response to pressing of the position of the object with the display changed, execute a function after the change different from a function before the change of the object with the display changed (fifth configuration).

According to the above-described fifth configuration, the number of types of functions that can be operated on the touch panel can be increased by the pressing force on the plurality of objects. Furthermore, since the display of the object changes in response to the pressing force on the other object, the user can recognize the function of the object being changed.

In any one of the first to fifth configurations, a content display configured to display contents of a moving picture or an image may be further included, the object may include thumbnail images of the contents, and the controller may be configured to cause the content display to display a content corresponding to a thumbnail image with the pressing force detected (sixth configuration).

According to the above-described sixth configuration, the content corresponding to the thumbnail image can be easily displayed on the content display by the pressing force by the user.

In the sixth configuration, the pressing force sensor may be configured to detect the magnitude of pressing force at at least two levels, the controller may further include a determination unit configured to determine whether a touch position is pressed based on the magnitude of pressing force at the touch position, the touch position being a position where the touch panel is touched, and the controller may be configured to cause the content display to display a preview image based on a thumbnail image corresponding to the touch position (seventh configuration).

According to the above-described seventh configuration, the user touches the touch panel, and while confirming the preview image corresponding to the touch position, presses the touch panel when a desired preview image is displayed, and thus the user can display a content desired by the user on the content display.

In any one of the first to fifth configurations, the display may include a content display region configured to display contents of a moving picture or an image, and a thumbnail image display region configured to display thumbnail images of the contents as a part of the object, and the controller may be configured to cause the content display region to display a content corresponding to a thumbnail image with the pressing force detected. (eighth configuration).

According to the above-described eighth configuration, the content corresponding to the thumbnail image can be easily displayed in the content display region by the pressing force by the user.

In the eighth configuration, the pressing force sensor may be configured to detect the magnitude of pressing force at at least two levels, the controller may further include a determination unit configured to determine whether a touch position is pressed based on the magnitude of pressing force at the touch position, the touch position being a position where the touch panel is touched, and the controller may be configured to cause the content display region to display a preview image based on a thumbnail image corresponding to the touch position (ninth configuration).

According to the above-described ninth configuration, the user touches the touch panel, and while confirming the preview image corresponding to the touch position, presses the touch panel when a desired preview image is displayed, and thus the user can display a content desired by the user on the content display region.

In any one of the first to ninth configurations, the pressing force sensor may be configured to detect the magnitude of pressing force at at least two levels, and the controller may be configured to determine the function of the object with the pressing force detected in accordance with the magnitude of pressing force (tenth configuration).

According to the above-described tenth configuration, the function of the object can be changed in accordance with the magnitude of the user pressing, and thus the function of the object provided on the touch panel can be increased.

In the tenth configuration, the plurality of objects may include a screen scroll object, and the display control unit may be configured to increase the speed of the screen scroll, as the magnitude of pressing force on the screen scroll object is larger (eleventh configuration).

According to the above-described eleventh configuration, in a case where the user desires to increase the speed of the screen scroll, the speed of the screen scroll can be easily increased by increasing the magnitude of pressing force.

In any one of the first to eleventh configurations, a vibrator configured to vibrate the touch panel may be further included, and the controller may be configured to cause the vibrator to vibrate the touch panel in a case where the pressing force on the object is detected, and cause the vibrator to vibrate the touch panel in a case where the cancellation of the pressing force on the object is detected (twelfth configuration).

According to the above-described twelfth configuration, the user can recognize by the vibration whether the pressing force on the touch panel is detected or whether the cancellation of the pressing force is detected.

In any one of the first to twelfth configurations, the pressing force sensor may be disposed closer to a touch surface side of the touch panel than the display (thirteenth configuration).

According to the above-described thirteenth configuration, the pressing force sensor is disposed at a position closer to the touch surface than the display, and thus the pressed position can be detected with high definition.

In any one of the first to thirteenth configurations, the display is a display having flexibility (fourteenth configuration).

According to the above-described fourteenth configuration, even in a case where the pressing force sensor is disposed on the opposite side to the touch surface of the touch panel than the display, the pressing force can be transmitted to the pressing force sensor via the display having flexibility while preventing the resolution of the pressing force sensor from being decreased.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. A display device with a touch panel, the display device comprising:
a display configured to display a plurality of objects;
a touch panel overlapped with the display in a plan view, the touch panel including a pressing force sensor configured to detect a pressing force in each of the plurality of objects; and
a controller configured to control the display and the touch panel,
wherein the controller is configured to control display of the display in accordance with a function of an object with a pressing force detected, among the plurality of objects.

2. The display device with the touch panel according to claim 1,
wherein the pressing force sensor is configured to detect a magnitude of pressing force at at least two levels, and
the controller further includes a determination unit configured to determine whether a touch position is pressed based on the magnitude of pressing force at the touch position, the touch position being a position where the touch panel is touched.

3. The display device with the touch panel according to claim 2,
wherein the controller is configured to cause the display to display a guide image after the determination unit determines that the touch position is pressed.

4. The display device with the touch panel according to claim 2,
wherein the controller further includes a movement amount acquisition unit configured to acquire a movement amount of a pointer based on coordinates of the touch position, and
the controller is configured to change, in accordance with the movement amount, a function of an object corresponding to the touch position determined to be pressed by the determination unit.

5. The display device with the touch panel according to claim 1,
wherein the controller is configured to
change display of at least one object other than the object with the pressing force detected, and
in response to pressing of the position of the object with the display changed, execute a function after the change different from a function before the change of the object with the display changed.

6. The display device with the touch panel according to claim 1, the display device further comprising:
a content display configured to display contents of a moving picture or an image,
wherein the object includes thumbnail images of the contents, and
the controller is configured to cause the content display to display a content corresponding to a thumbnail image with the pressing force detected.

7. The display device with the touch panel according to claim 6,
wherein the pressing force sensor is configured to detect a magnitude of pressing force at at least two levels,
the controller further includes a determination unit configured to determine whether a touch position is pressed based on the magnitude of pressing force at the touch position, the touch position being a position where the touch panel is touched, and
the controller is configured to cause the content display to display a preview image based on a thumbnail image corresponding to the touch position.

8. The display device with the touch panel according to claim 1,
wherein the display includes a content display region configured to display contents of a moving picture or an image, and a thumbnail image display region configured to display thumbnail images of the contents as a part of the object, and
the controller is configured to cause the content display region to display a content corresponding to a thumbnail image with the pressing force detected.

9. The display device with the touch panel according to claim 8,
wherein the pressing force sensor is configured to detect a magnitude of pressing force at at least two levels,
the controller further includes a determination unit configured to determine whether a touch position is pressed based on the magnitude of pressing force at the touch position, the touch position being a position where the touch panel is touched, and
the controller is configured to cause the content display region to display a preview image based on a thumbnail image corresponding to the touch position.

10. The display device with the touch panel according to claim 1,
wherein the pressing force sensor is configured to detect the magnitude of pressing force at at least two levels, and
the controller is configured to determine the function of the object with the pressing force detected in accordance with the magnitude of pressing force.

11. The display device with the touch panel according to claim 10,
wherein the plurality of objects include a screen scroll object, and
the controller is configured to increase a speed of screen scroll as the magnitude of pressing force on the screen scroll object is larger.

12. The display device with the touch panel according to claim 1, the display device further comprising:
a vibrator configured to vibrate the touch panel,
wherein the controller is configured to cause the vibrator to vibrate the touch panel in a case where a pressing force on an object is detected, and cause the vibrator to vibrate the touch panel in a case where cancellation of the pressing force on the object is detected.

13. The display device with the touch panel according to claim 1,
wherein the pressing force sensor is disposed closer to a touch surface side of the touch panel than the display.

14. The display device with the touch panel according to claim 1,
wherein the display is a display having flexibility.
